(19) United States
(12) Patent Application Publication
(10) Pub. No.: US 2005/0022440 A1
(43) Pub. Date: Feb. 3, 2005

(54) Waterfowl decoy device

(76) Inventor: Eric Pinkston, Elmer, MO (US)

Correspondence Address: Edward A. McConwell, Jr., 5925 Beverly, Mission, KS, 66202, US

(21) Appl. No.: 10/931,888

(22) Filed: Sep. 1, 2004

Related U.S. Application Data
(63) Continuation of application No. 10/375,872, filed on Feb. 26, 2003, now abandoned.

(51) Int. Cl. A01M 31/06

(52) U.S. Cl. 43/3

(57) ABSTRACT

A waterfowl decoy device broadly comprises a buoyant decoy body, a decoy anchor, and an anchor extension, setting and retrieval mechanism for extending, setting and retrieving the anchor. The body is a conventional waterfowl decoy body defining a hollow interior and presenting a keel. The mechanism is attached to the body and includes a housing, a reel mounted within the housing for rotation and an anchor line having a proximal end coupled with the reel and a distal end coupled with the anchor. The reel is spring biased for retraction of the anchor. The decoy is retrieved by pushing the decoy into the water so that the decoy bobs in a direction away from the anchor unlocking the mechanism and retracting the anchor.

### BACKGROUND OF THE INVENTION

1. Field of the Invention

The present invention relates generally to a waterfowl decoy. More particularly the present invention relates to a waterfowl decoy having an improved anchoring mechanism and an improved method of deploying and retrieving the decoy.

2. Discussion of the Prior Art

Waterfowl decoys are commonly used in hunting waterfowl. In such applications, a plurality of decoys are generally placed in a desired location for attracting waterfowl to the location. Conventional waterfowl decoys include a hollow, buoyant body having a keel, an elongated anchor and an anchor line having a proximal end coupled with the decoy body and a distal end coupled with the anchor. The anchor is constructed from a flexible, resilient material, such as lead. In a stored condition, the anchor line is wrapped around the keel and the anchor is bent around a portion of the keel, thereby clipping the anchor to the body and preventing the anchor line from unwrapping prematurely.

In use, such a prior art decoy is deployed by unclipping the anchor from the keel and unwrapping the anchor line. The decoy is then positioned in a desired location on the water and the anchor is cast into the water for preventing the decoy from floating away from the location. The decoy is retrieved by picking up the decoy and wrapping the anchor line around the keel and clipping the anchor to the keel.

Due to the fact that the anchor line is a fixed length and is not easily adjustable, the amount of area that the decoy is permitted to float around on is varied depending on the depth of the body of water. As a result, in relatively shallow water, the anchor lines of a field of decoys may become excessively intertwined and tangled, complicating the retrieval of the decoys. In addition, waterfowl hunting commonly takes place in relatively cold environments during the fall, winter and early spring months. The act of picking up each decoy and wrapping the anchor lines takes a significant amount of time and may require a person picking up the decoys to remove their gloves, further exposing the person to the elements and possibly leading to hypothermia or other cold weather afflictions. It will be appreciated that in large decoy fields of 100 or more decoys the cleanup may take a half hour or more, often while standing in water, albeit in waterproof bibs or waders, barely warmer than 0° C. This time requirement reduces the amount of time a hunter has to hunt because the hunter will desire to pick up the decoys prior to full dark for safety's sake.

Recent improvements in the art of waterfowl decoys include providing a spring biased anchor line reel disposed within the body of the decoy. The anchor line is trained through a port in the body of the decoy and unwound for deploying the anchor. To set the anchor, a lock is clipped to the anchor line adjacent to the body, preventing retraction of the anchor line. Retraction of the anchor merely requires releasing the lock from the anchor line so that the reel rewinds, pulling and retrieving the anchor.

While such a decoy does reduce the time to pick up a decoy, such a decoy may undesirably take on water through the anchor line port in the body resulting in additional retrieval time in order to drain the decoy, and possibly resulting in the decoy sinking. Releasing the lock from the anchor line also may require removal of gloves, and the like, resulting in exposure to the elements. In addition, due to the positioning of the reel within the decoy body, conventional decoys are not suited to be adapted for such a configuration without cutting the decoy open. Such an action is time consuming and may not yield a sound buoyant body after modification.

### BRIEF SUMMARY OF THE INVENTION

An improved waterfowl decoy device comprises a buoyant decoy body, a decoy anchor, and an anchor extension, setting and retrieval mechanism for extending, setting and retrieving the anchor. The body is a conventional waterfowl decoy body, such as a duck decoy body or goose decoy body, and defines a hollow interior. The body also includes an exterior surface having upper and lower portions, the lower portion presenting a keel.

The mechanism is attached to the body and includes a housing, a reel mounted within the housing for rotation in first and second directions and an anchor line having a proximal end coupled with the reel and a distal end coupled with the anchor. The anchor line is spooled around the reel. The anchor is configured for depending from the body via the anchor line when the decoy body is placed in a body of water and resting on the bottom surface of the water thereby preventing the device from floating away from a desired location.

The mechanism also includes extension means for extending the anchor from the mechanism toward an extended position as the reel is rotated in the first direction, setting means for setting the anchor in an extended position as the reel is rotated in the second direction, releasing means for releasing the anchor from the extended position as the reel is rotated in the first direction, and retrieval means for retrieving the anchor from the extended position as the reel is rotated in the second direction.

A method of deploying and retrieving the decoy device comprises the steps of pulling the anchor line in a direction away from the mechanism to extend the anchor to the extended position through a series of rotations of the reel in the first direction, releasing the anchor line for rotation of the reel in the second direction to a lockout position, placing the decoy in a body of water, moving the reel in the first direction thereby releasing the reel from the lockout position, and permitting movement of the reel in the second direction until the anchor is in close proximity to the mechanism. The reel is released from the lockout position by pushing the decoy into the water so that the decoy bobs in a direction away from the anchor thereby rotating the reel in the first direction.

### BRIEF DESCRIPTION OF THE SEVERAL VIEWS OF THE DRAWINGS

A preferred embodiment of a waterfowl decoy device and a method of using the device are described in detail below with reference to the drawing figures, wherein:

FIG. 1 is a side elevation view of a waterfowl decoy device constructed in accordance with a preferred embodiment of the present invention showing the device deployed in a body of water;

FIG. 2 is a side elevation view of the device of FIG. 1 showing the anchor in a retracted position;

FIG. 3 is a front elevation view of the device of FIG. 2;

FIG. 4 is a side elevation view of the mechanism of the present invention;

FIG. 5 is cut away top view of the extension, setting and retrieval mechanism of the present invention showing the anchor in a retracted position;

FIG. 6 is a cut away top view of the mechanism as the anchor is being extended from the mechanism toward an extended position;

FIG. 7 is a cut away top view of the mechanism showing the anchor in an extended position and the reel in a lockout position; and

FIG. 8 is a perspective view of the reel showing the upper face of the reel.

### DETAILED DESCRIPTION OF THE PREFERRED EMBODIMENT

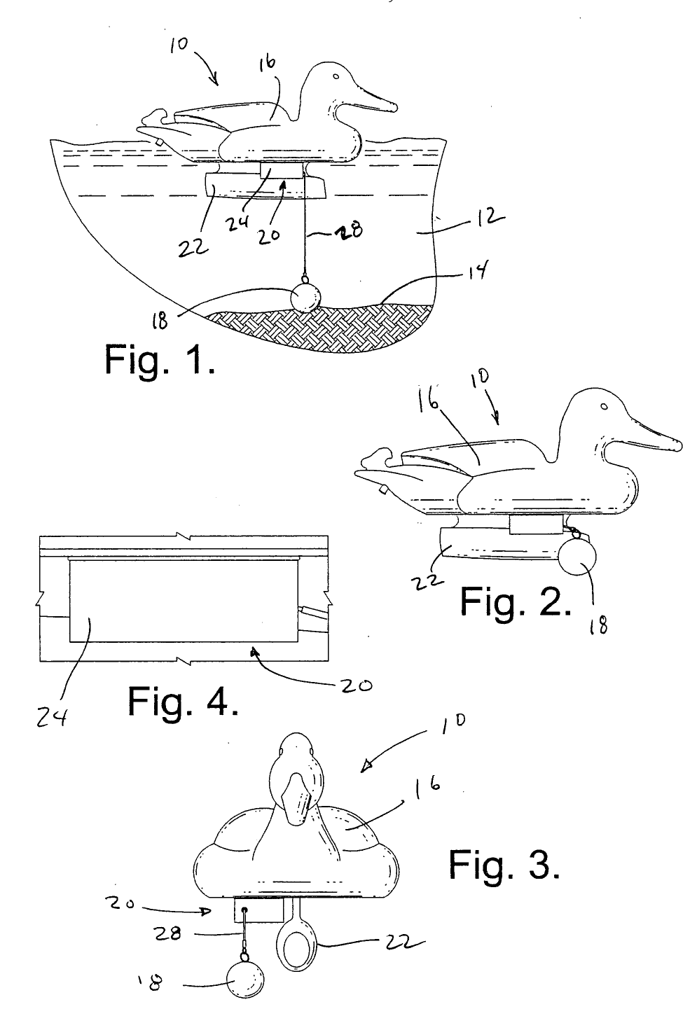

Referring now to the drawings, FIG. 1 depicts a preferred embodiment of an improved waterfowl decoy device 10 deployed in a body of water 12 having a bottom surface 14. The decoy 10 broadly comprises a decoy body 16, a decoy anchor 18, and an anchor extension, setting and retrieval mechanism 20 for extending, setting and retrieving the anchor 18.

The body 16 is a conventional waterfowl decoy body, such as a duck decoy body or goose decoy body, constructed of synthetic resin material through an injection molding process and defines a hollow interior. As a result, the decoy body 16 is buoyant. The body 16 may alternatively be constructed from other buoyant material, such as cork, or relatively light weight wood. The body 16 also includes an exterior surface having upper and lower portions, the lower portion presenting a keel 22. The keel 22 assists in stabilizing the decoy body 12 with the upper portion generally above water while floating.

The mechanism 20 is attached to the exterior surface of the body 12 by an adhesive material or other conventional means. As a result, conventional waterfowl decoys may be retrofitted with the mechanism 20 without the added cost of purchasing an entirely new decoy.

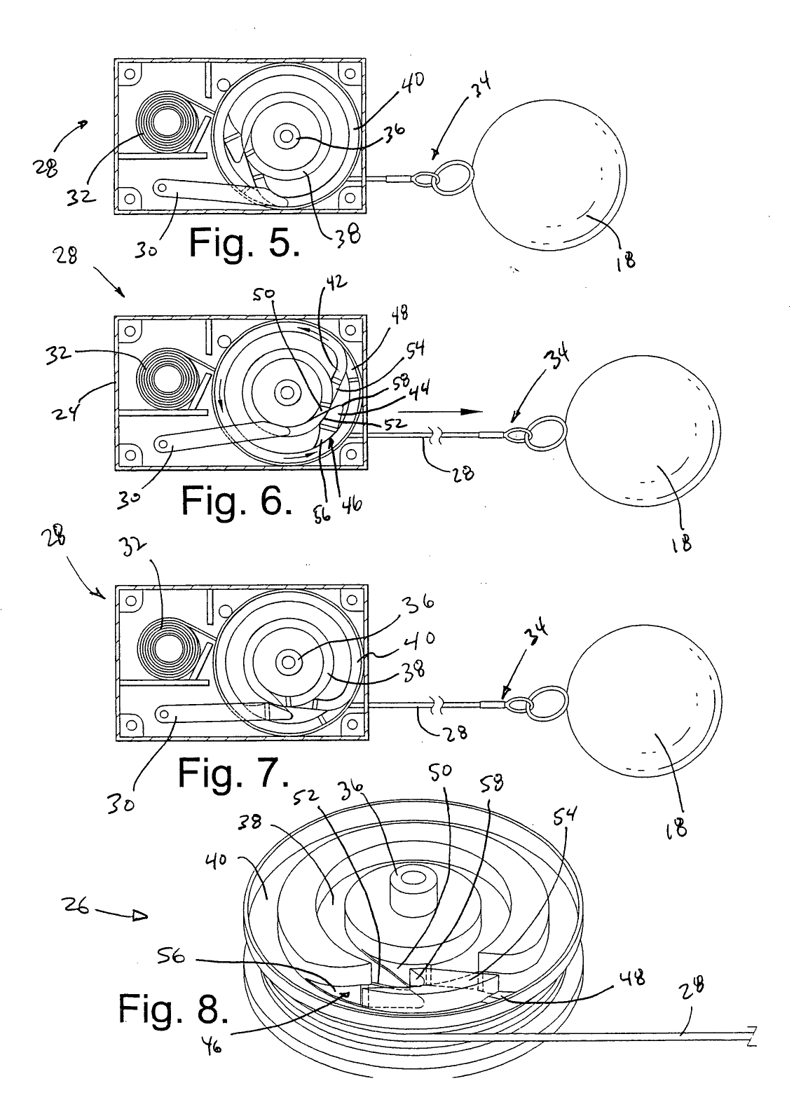

As shown in FIG. 5, the mechanism 20 includes a housing 24, a reel 26 disposed within the housing 24, an anchor line 28, a guide 30 and a spring 32. The housing includes interior structure defining a guide axle and a pair of opposed, reel axles. The reel 26 is mounted within the housing 24 on the reel axles for rotation in a first, counterclockwise direction and a second, clockwise direction. The guide 30 includes a guidepost (not shown) and is mounted within the housing 24 on the guide axle for pivotal movement and for engagement with the reel 26 during rotation of the reel 26. The guide 30 and reel 26 are preferably constructed from similar material, such as synthetic resin material, to prevent excessive wearing of one of the guide 30 and reel 26 against the other.

The anchor line 28 includes a proximal end coupled with the reel 26 and a distal end 34 coupled with the anchor 18. The proximal end of the anchor line 28 is spooled around the reel 26 for selective extension and retrieval of the anchor 18.

The anchor 18 is a conventional leaded weight of approximately 5 ounces when used with a duck decoy, as depicted. Other types of waterfowl decoys may be larger, such as goose decoys. Therefore, in such applications, a larger weight of between about 12-16 ounces may be used. The anchor 18 is configured for depending from the body 12 via the anchor line 28 when the body 12 is placed in water to rest on the bottom surface 14 to inhibit movement of the body 12 away from a desired location.

The reel 26 presents an upperface defining an upper hub 36, an inner, extension track 38, an outer, retrieval track 40, a switch track 42, a lockout track 44 and a release track 46. The tracks 38-46 are interconnected and sized for receiving the guide post. The upperface of the reel 26 also presents a switch ridge 48, a lockout ridge 50, a release ridge 52, an extension ridge 54 and a retrieval ridge 56. Each of ridges 48-56 presents opposed vertical and angled faces.

The reel 26 also presents a lower face defining a lower hub (not shown). The spring 32 includes a distal end coupled with the lower hub of the reel 26 that spools about the lower hub as the reel 26 is rotated in the first, counterclockwise direction. The spring 32 is constructed from material having a memory and provides a constant force toward the second direction of rotation during rotation of the reel 26 in the first or second directions. As a result, the spring 32 provides a biasing means for biasing the reel 26 in the second direction of rotation. The biasing force of the spring 32 is greater than the weight of the anchor 18 so that the spring 32 is able to retrieve the anchor 18.

The combination of the guide 30, the spring 32, tracks 38-46 and ridges 48-56 provide means for extending, setting, releasing and retrieving the anchor 18 to and from the extended position. Referring again to FIG. 5, the mechanism 20 is shown with the anchor 18 in a retracted position. In this position, the guide 30 engages the outer, retrieval track 40. As the anchor 18 is pulled away from the mechanism 20, the reel 26 rotates counterclockwise and brings the guide post into engagement with the vertical face of the switch ridge 48. The switch ridge 48 urges the guide post into the switch track 42 and then into the inner, extension track 38, as shown in FIG. 6. The anchor 18 may then be pulled from the mechanism 20 through multiple rotations of the reel 26, until the anchor line 28 is payed out to a desired length, thus placing the anchor 18 in the extended position.

By letting go of the anchor 18, the spring 32 causes the reel 26 to rotate clockwise. The guide post then travels along the extension track 38 until engaging the vertical face of the lockout ridge 50. The lockout ridge 50 urges the guide post into the lockout track 44 and into engagement with a V-shaped lockout wall 58, as shown in FIG. 7. The wall 58 prevents further movement of the reel 26 in the clockwise direction, thus setting the reel 26 in a lockout position and the anchor in the desired extended position. It will be appreciated that the length of the anchor line 28 payed out may be adjusted by lengths approximately equal to the circumference of the reel 26. As a result, the mechanism 20 provides a means of setting variable lengths of the anchor line 28.

Pulling the anchor 18, or anchor line 28 again away from the mechanism 20, the reel 26 is rotated in the first, counterclockwise direction. The vertical face of the release ridge 52 urges the guide post to travel into the release track 46 and then into the retrieval track 40. The preferred reel 26 has a diameter of approximately 1½ inches. By pulling the anchor line 28 to pay out approximately an additional ¼ inch of line 28, the guide post is moved into the retrieval track 40. By again letting go of the anchor 18 or line 28, the spring 32 rotates the reel 26 in the second, clockwise direction and the retrieval ridge 56 keeps the guide post in the retrieval track 40, permitting rotation of the reel 26 until the anchor 18 is in the retracted position.

If, alternatively, more anchor line 28 is desired to be payed out than originally set, the anchor line 28 is simply pulled at least one full rotation of the reel 26 in the first, counterclockwise direction so that the guide post once again enters the extension track 38. The anchor 18 is then set and retrieved as discussed above.

A preferred inventive method of deploying and retrieving the decoy device 10 begins by pulling the anchor line 28 in a direction away from the mechanism 20 to extend the anchor 18 to the desired extended position through a series of rotations of the reel 26 in the first, counterclockwise direction. The anchor line 28 is then released so that the reel 26 rotates in the second, clockwise direction to the lockout position. The decoy body 16 is placed in a body of water 12, the anchor 18 preventing the body 16 from floating away from the desired location.

Once it is desired to retrieve the decoy device 10, the reel 26 is released from the lockout position. For example, moving the reel 26 in the first, counterclockwise direction so that the guide post clears the release track 46 but less than one full rotation releases the reel 26 from the lockout position, and permits movement of the reel 26 in the second, clockwise direction until the anchor 18 is in the retracted position in close proximity to the mechanism 20.

The reel 26 is preferably released from the lockout position by pushing the decoy body 16 into the water 12 so that the body 16 bobs in a direction away from the anchor 16, rotating the reel 26 in the first, counterclockwise direction. By pushing the buoyant body 16 into the water 12, the body 16 bobs upwardly, away from the anchor 18, momentarily inducing an added force on the reel 26 in the first, counterclockwise direction. This added force when combined with the weight of the anchor 18 and deployed anchor line 28 is greaterthan biasing force of the spring 32 thereby inducing momentary movement of the reel 26 in the first direction so that the guide post clears the release track 46. This movement releases the reel 26 from the lockout position so that the biasing force, once the added force dissipates, causes the reel 26 to rotate in the second, clockwise direction, retrieving the anchor 18 from the bottom surface 14.

Alternatively, the decoy body 16 may be pulled briskly upwardly, inducing the necessary added force to the reel 26 in the first, counterclockwise direction, releasing the reel 26 from the locked position. Once the reel 26 is released and the added force dissipates, the spring 32 rotates the reel 26 in the second, clockwise direction, retrieving the anchor 18.

Although the invention has been described in the above preferred embodiment with reference to the drawing figures, it is understood that substitutions may be made and equivalents employed herein with departing from the scope of the invention as set forth in the following claims.

1. A waterfowl decoy device comprising:
a buoyant decoy body;
a decoy anchor; and
an anchor extension, setting and retrieval mechanism for extending, setting and retrieving the anchor, the mechanism including a housing, a reel mounted within the housing for rotation in first and second directions and an anchor line having a first end coupled with the reel and a second end coupled with the anchor, the reel presenting a first face defining interconnected, concentric extension and retrieval tracks, the mechanism also including a guide post engaging the face of the reel.

2. The waterfowl decoy device as set forth in claim 1, wherein the mechanism further includes biasing means for biasing the reel in the second direction.

3. The waterfowl decoy device as set forth in claim 2, wherein the biasing means includes a generally constant force memory spring biasing the reel in the second direction with a generally constant force during rotation of the spring in the first direction.

4. The waterfowl decoy device as set forth in claim 3, wherein the force exerted by the spring is greater than the weight of the anchor.

5. The waterfowl decoy device as set forth in claim 1, wherein the body presents a lower portion and the mechanism is adhesively attached to the lower portion of the body.

6. The waterfowl decoy device as set forth in claim 1, wherein the body presents an exterior surface and the mechanism is attached to the exterior surface of the body.

7. A waterfowl decoy device comprising:
a buoyant decoy body;
a decoy anchor; and
an anchor extension, setting and retrieval mechanism attached to the body for extending, setting and retrieving the anchor, the mechanism including a housing having an outer wall structure, a reel mounted on the wall structure within the housing for rotational movement in first and second directions, the reel presenting a first face defining interconnected, concentric extension and retrieval tracks, and switch, lockout and release tracks interconnected with the extension and retrieval tracks, an anchor line having a first end coupled with the reel and a second end coupled with the anchor, and a guide pivotally mounted within the housing on the wall structure for engagement with the tracks of the reel.

8. The waterfowl decoy device as set forth in claim 7, wherein the mechanism further includes biasing means for biasing the reel in the second direction.

9. The waterfowl decoy device as set forth in claim 8, wherein the biasing means includes a generally constant force memory spring biasing the reel in the second direction with a generally constant force during rotation of the spring in the first direction.

10. The waterfowl decoy device as set forth in claim 9, wherein the force exerted by the spring is greater than the weight of the anchor.

11. The waterfowl decoy device as set forth in claim 9, wherein the spring is constructed from corrosion resistant material.

12. The waterfowl decoy device as set forth in claim 7, wherein the reel and guide are constructed from similar synthetic resin materials.

13. The waterfowl decoy device as set forth in claim 7, wherein the first face of the reel defines an extension ridge for directing the guide from the retrieval track toward the switch track and then the extension track as the reel rotates in the first direction.

14. The waterfowl decoy device as set forth in claim 7, wherein the first face of the reel defines a lockout ridge for directing the guide from the extension track toward the lockout track as the reel rotates in the second direction, the guide inhibiting movement of the reel in the second direction while in the lockout track.

15. The waterfowl decoy device as set forth in claim 7, wherein the first face of the reel defines a release ridge for directing the guide from the lockout track toward the release track and then the release track as the reel is rotated in the first direction.

16. A method of deploying and retrieving a waterfowl decoy comprising the steps of:
providing a waterfowl decoy including a buoyant body, a decoy anchor and an anchor extension, setting and retrieval mechanism attached to the body, the mechanism including a reel and an anchor line having a first end coupled with the reel and second end coupled with the anchor, the reel mounted in the mechanism for rotation in first and second directions for extending and retrieving the anchor line, respectively;
pulling the anchor line in a direction away from the mechanism to extend the anchor toward an extended position through a series of rotations of the reel in the first direction;
releasing the anchor line for rotation of the reel in the second direction to a lockout position thereby setting the anchor in the extended position;
placing the decoy in a body of water;
moving the anchor line to move the reel in the first direction thereby releasing the reel from the lockout position; and
permitting movement of the reel in the second direction until the anchor is in close proximity to the mechanism.

17. The method as set forth in claim 16, wherein the step of moving the anchor line to move the reel in the first direction is accomplished by pushing the decoy into the water so that the decoy bobs in a direction away from the anchor thereby rotating the reel in the first direction.

18. The method as set forth in claim 16, wherein during the step of moving the anchor line to move the reel in the first direction, the reel is moved less than one rotation in the first direction.
